(19) United States
(12) Patent Application Publication
(10) Pub. No.: US 2018/0167418 A1
(43) Pub. Date: Jun. 14, 2018

(54) APPARATUS AND METHOD FOR LAWFUL INTERCEPTION

(71) Applicant: NOKIA SOLUTIONS AND NETWORKS OY, Espoo (FI)

(72) Inventors: Tommy Johannes LINDGREN, Espoo (FI); Sumanta SAHA, Espoo (FI); Jani Olavi SODERLUND, Vantaa (FI); Niko Markus SAVOLAINEN, Kerava (FI)

(21) Appl. No.: 15/892,932

(22) Filed: Feb. 9, 2018

Related U.S. Application Data
(62) Division of application No. 14/917,343, filed on Mar. 8, 2016.

(51) Int. Cl. H04L 29/06; H04W 12/02

(52) U.S. Cl. CPC H04L 63/306; H04W 12/02; H04L 63/0428

(57) ABSTRACT

Apparatus and method for lawful interception in accordance with an example embodiment of the present invention, a method is provided for receiving from a gateway apparatus an intercept request regarding user equipment in the communication system; creating or modifying a processing rule regarding the user equipment by including interception in the rule; transmitting to a network switch processing user equipment connections a command to clone and encrypt each signalling or data packet of the user equipment connection and to transmit the encrypted signalling and data packets to a given network apparatus.

### CROSS REFERENCE TO RELATED APPLICATION:

This application is a Divisional Application of U.S. patent application Ser. No. 14/917,343 filed on Mar. 8, 2016 which is a 371 Application of International Patent Application No. PCT/EP2013/068533, filed Sep. 9, 2013. The contents of these applications are hereby incorporated by reference.

### Field of the invention

The present invention relates to lawful interception in a communication system. Embodiments of the invention relate to communication systems utilising Software Defined Networking.

### BACKGROUND OF THE INVENTION

Wireless communication systems are constantly under development. Developing systems provide a cost-effective support of high data rates and efficient resource utilization. One communication system under development is the 3rd Generation Partnership Project (3GPP) Long Term Evolution (LTE). An improved version of the Long Term Evolution radio access system is called LTE-Advanced (LTE-A). The LTE is designed to support various services, such as high-speed data, multimedia unicast and multimedia broadcast services.

In most countries, lawful authorities require that data transferred in communication systems may be monitored if such a need arises. The data may comprise both payload data of a given connection and/or data related to signalling or network management of the connection. The process may be called lawful interception (LI). The lawful authorities may be law enforcement agencies (LEAs), intelligence authorities or other government agencies allowed performing such activities under the local law.

For this reason modern communication systems are equipped with LI functionality. Typically LI functionality captures and stores all signalling (interception-related information, IRI) and user plane payload (communication content, CC) traffic which is then sent to an LI centre for further analysis with e.g. decoding tools. All signalling and data transfer between LI centre and network elements must be encrypted in order to hide from unwanted parties the identities of subscribers under intercept.

Lawful intercept functionality is very resource intensive and may impact network element performance.

### SUMMARY OF THE INVENTION

Various aspects of examples of the invention are set out in the claims.

According to an aspect, an apparatus in a communication system is provided, comprising: at least one processor; and at least one memory including computer program code, the at least one memory and the computer program code configured to, with the at least one processor, cause the apparatus at least to perform: receive from a gateway apparatus an intercept request regarding user equipment in the communication system; create or modify a processing rule regarding the user equipment by including interception in the rule; transmit to a network switch processing user equipment connections a command to clone and encrypt each signalling or data packet of the user equipment connection and to transmit the encrypted signalling and data packets to a given network apparatus.

According to an aspect, an apparatus in a communication system is provided, comprising: at least one processor; and at least one memory including computer program code, the at least one memory and the computer program code configured to, with the at least one processor, cause the apparatus at least to perform: process user equipment connections by directing data signalling packets between user equipment and a gateway apparatus; receive from a controlling network element an intercept command related to a given user equipment connection; clone each signalling or data packet of the given user equipment connection; encrypt the cloned signalling and data packets; and transmit the encrypted signalling and data packets to a given network apparatus.

According to an aspect, an apparatus in a communication system is provided, comprising: at least one processor; and at least one memory including computer program code, the at least one memory and the computer program code configured to, with the at least one processor, cause the apparatus at least to perform: receive from a network apparatus an intercept request regarding user equipment in the communication system, obtain information that a connection has been set up for the user equipment; transmit to an OpenFlow Controller apparatus a command to intercept user equipment connection, the command comprising identification of the connection; transmit to the network apparatus interception related information (IRI).

According to an aspect, there is provided a method, comprising: receiving from a gateway apparatus an intercept request regarding user equipment in the communication system; creating or modifying a processing rule regarding the user equipment by including interception in the rule; transmitting to a network switch processing user equipment connections a command to clone and encrypt each signalling or data packet of the user equipment connection and to transmit the encrypted signalling and data packets to a given network apparatus.

According to an aspect, there is provided a method in a communication system, comprising: processing user equipment connections by directing data signalling packets between user equipment and a gateway apparatus; receiving from a controlling network element an intercept command related to a given user equipment connection; cloning each signalling or data packet of the given user equipment connection; encrypting the cloned signalling and data packets; and transmitting the encrypted signalling and data packets to a given network apparatus.

According to an aspect, there is provided a method in a communication system, comprising: receiving from a network apparatus an intercept request regarding user equipment in the communication system, obtaining information that a connection has been set up for the user equipment; transmitting to an OpenFlow Controller apparatus a command to intercept user equipment connection, the command comprising identification of the connection; transmitting to the network apparatus interception related information (IRI).

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a communication environment;

FIG. 2 illustrates an example of a Software Defined Networking realization of a gateway;

FIG. 3 illustrates an example realization of lawful interception;

FIG. 4 illustrates an embodiment of the invention;

FIG. 5 is a signalling chart illustrating an embodiment of the invention; and

FIG. 6 shows an example of a block diagram of the structure of an apparatus according to an example embodiment.

### DETAILED DESCRIPTION

Some embodiments of the present invention are applicable to network elements, a corresponding component, and/or to any communication system or any combination of different communication systems that support required functionalities.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

Many different radio protocols to be used in communications systems exist. Some examples of different communication systems are the universal mobile telecommunications system (UNITS) radio access network (UTRAN), HSPA (High Speed Packet Access), long term evolution (LTE®, known also as evolved UMTS Terrestrial Radio Access Network E-UTRAN), long term evolution advanced (LTE-A), Wireless Local Area Network (WLAN) based on IEEE 802.11 standard, worldwide interoperability for microwave access (WiMAX®), Bluetooth®, personal communications services (PCS) and systems using ultra-wideband (UWB) technology. IEEE refers to the Institute of Electrical and Electronics Engineers. For example, LTE® and LTE-A are developed by the Third Generation Partnership Project 3GPP.

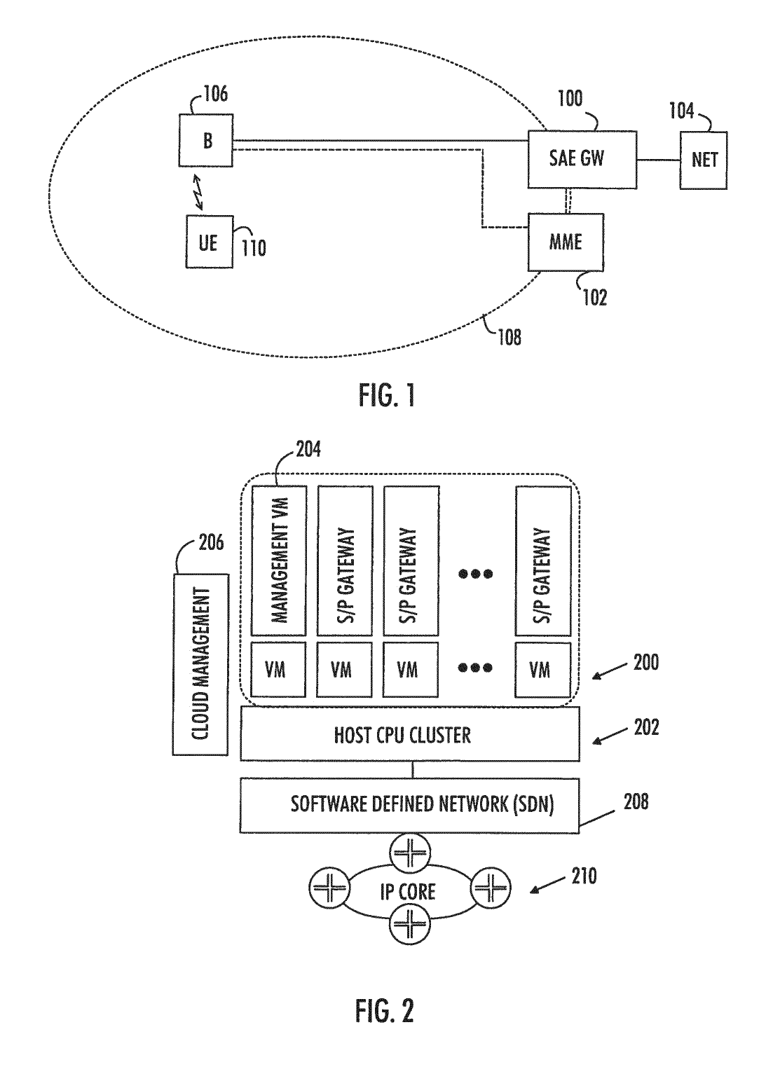

FIG. 1 illustrates a simplified view of a communication environment only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for communication are irrelevant to the actual invention. Therefore, they need not to be discussed in more detail here.

In the example of FIG. 1, a radio system based on LTE/SAE (Long Term Evolution/System Architecture Evolution) network elements is shown. However, the embodiments described in these examples are not limited to the LTE/SAE radio systems but can also be implemented in other radio systems.

The simplified example of a network of FIG. 1 comprises a SAE Gateway 100 and an MME 102. The SAE Gateway and the MME are part of the Evolved Packer Core (EPC) of the network. The SAE Gateway 100 provides a connection to Internet 104. FIG. 1 shows an eNodeB 106 serving a cell 108. In the example of FIG. 1, user equipment UE 110 is camped on the eNodeB 106.

The eNodeBs (Enhanced node Bs) of a communication system may host the functions for Radio Resource Management: Radio Bearer Control, Radio Admission Control, Connection Mobility Control, Dynamic Resource Allocation (scheduling). The MME 102 (Mobility Management Entity) is responsible for the overall UE control in mobility, session/call and state management with assistance of the eNodeBs through which the UEs connect to the network. The SAE GW 100 is an entity configured to act as a gateway between the network and other parts of communication network such as the Internet for example. The SAE GW may be a combination of two gateways, a serving gateway (S-GW) and a packet data network gateway (P-GW).

In mobile communication systems, user sessions are established as tunnels between UEs and Gateways (GW). Due to cellular network architecture, gateways are the aggregation points for the user sessions, providing the anchor towards the services in the Internet or operator service network. As illustrated above, in LTE the gateway is the SAE-GW element. In third generation 3G networks the gateway is GGSN (Gateway GPRS Support Node). The number of gateway elements in an operator network ranges from the minimum two to up to twenty, depending on the size of the operator's subscriber base, redundancy requirements, site strategy, element capacity, and so forth. As the market demands higher aggregation capabilities, only few elements are expected to stay in a network. The user sessions are distributed across the gateway elements.

In current systems, existing EPC gateways (S-GW, P-GW) are built as stand-alone network elements using dedicated hardware. In the future, also mobile gateways are likely to be implemented as a software only solution running over generic hardware that may be virtualized.

To increase the capacity and simplify the control of the EPC of communication networks Software Defined Networking (SDN) may be utilised to separate control and data planes. For example, to address gateway user plane requirements it is possible that a SDN based solution is used in combination with virtualized hardware.

FIG. 2 illustrates an example of an SDN realization of a gateway. In the example, the gateway is realized with one or more virtual machines 200 running over generic hardware 202 which may be realized using a cluster of computers, for example. The realization may comprise a management virtual machine 204 and cloud management module 206.

The gateway is connected to a Software Defined Network 208 which is connected to Internet Protocol/MultiProtocol Label Switching (IP MPLS) core 210.

In an embodiment, the SDN realization of the evolved packet core comprises a switch which transfers all user plane and control plane packets from eNodeBs to a gateway (and vice versa). The switch may be controlled using OpenFlow protocol by an Open Flow controller.

OpenFlow is a communications protocol providing access to a for-warding plane of a network switch or router over the network. OpenFlow is a standard communications interface defined between the control and forwarding layers of an SDN architecture. OpenFlow provides direct access to a forwarding plane of network devices such as switches and routers, both physical and virtual. Open networking foundation (ONF) is an organization promoting and adopting software-defined networking and OpenFlow.

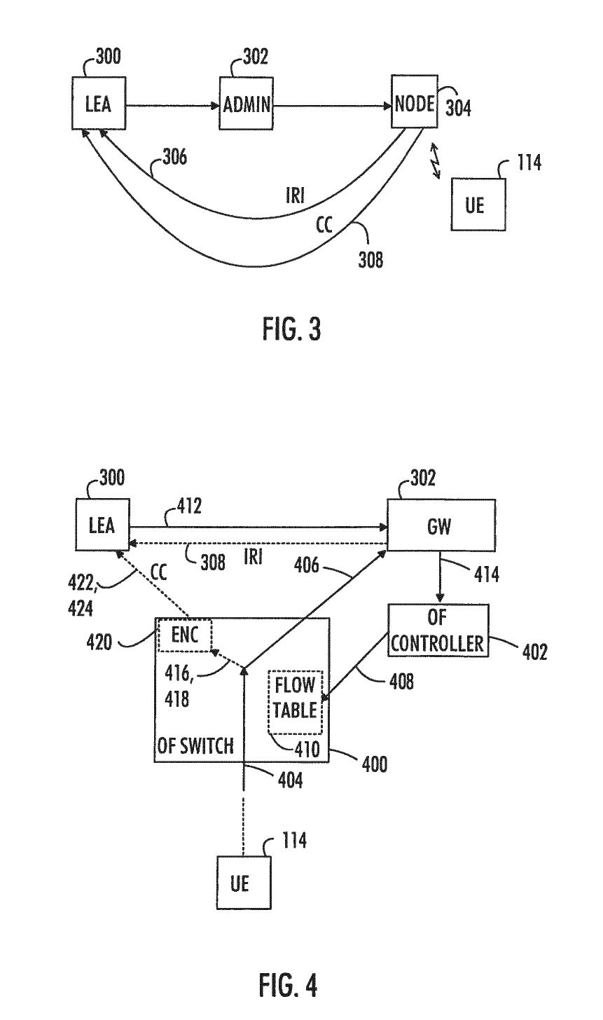

In lawful interception, lawful authorities require that data of a given connection may be monitored. The data may comprise both payload data of a given connection and/or data related to signalling or network management of the connection. FIG. 3 illustrates an example realization of lawful interception (LI). A law enforcement agency (LEA) 300 may request communication system control 302 that traffic of a given UE 114 is monitored. The control instructs a network element 304 transferring data to intercept and copy the data. The data may comprise interception related information IRI (network related data) 306 and user plane payload (communication content CC) 308. which are cloned and transmitted to the LEA 300. The IRI and CC are encrypted prior transmission so that it may not be monitored by unwanted parties.

In a cloud based EPC solution the performance per computing instance is expected to be lower than currently in a bare metal solution (due to virtualization overhead and need to use x86 architecture). In EPC the data rates are so high that the LI functionality may overload the computing resources unexpectedly. Furthermore, it is typically required that subscribers under interception must not be possible to identify via Operation and Maintenance (O&M) interfaces or even via statistical methods in a given interface or computing node. This might be a problem in virtualized gateway serving less sessions per instance than in current stand-alone network element.

Additionally, as all LI data transfer must be encrypted a lot of computing power is required especially in a virtualized environment which cannot use hardware acceleration for encryption implementation. Therefore with virtualized product, it is seen problematic to implement LI functionality in the same fashion as part of application software.

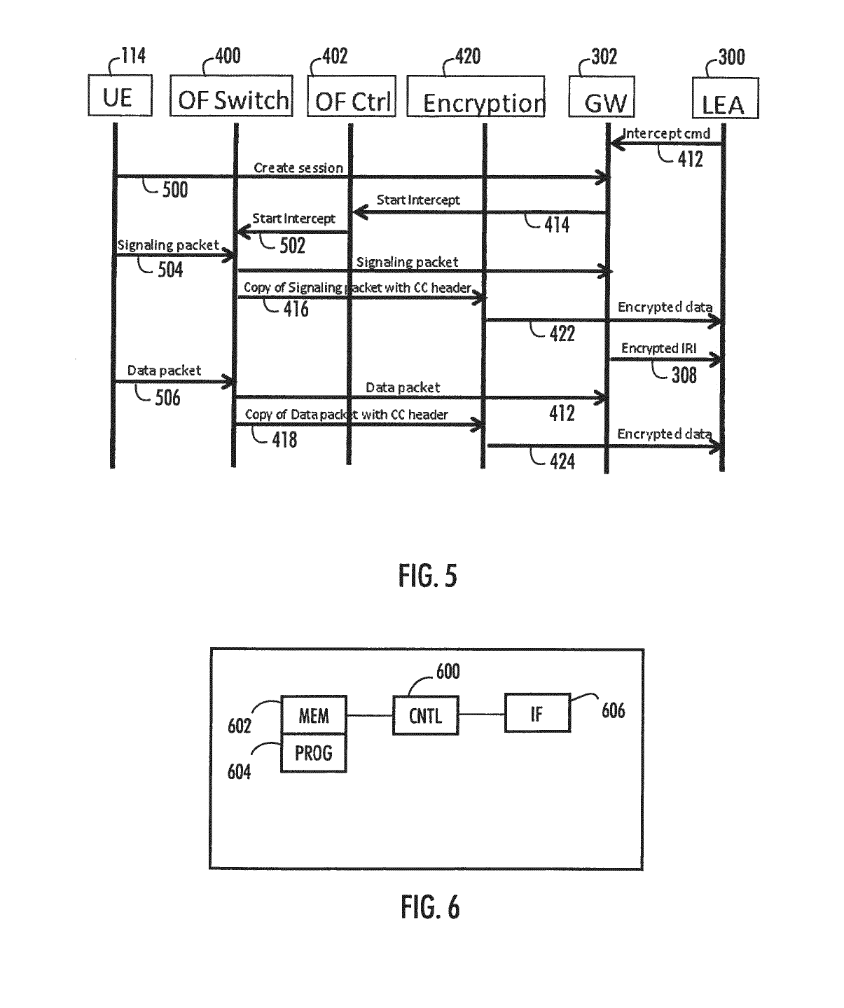

FIG. 4 and signalling chart of FIG. 5 illustrate an embodiment of the invention. FIG. 4 illustrates how an OpenFlow Switch 400 controlled by an OpenFlow Controller 402 receive packets 404 from user equipment 114 and forward 406 the packets to the Gateway apparatus 302.

The OpenFlow Controller 402 controls the OpenFlow Switch 400 using a secure channel 408 using OpenFlow protocol. The controller is configured to send the switch flow specifications which control the flow of packets 404. The switch may store the flow specifications in a flow table 410. The flow specifications may be considered as a set of rules indicating how the OpenFlow Switch 400 is to process data packets. In an embodiment, the rules identify packets using headers. The header of each received packet is determined and the flow table is checked for rules. If a rule for the determined header are found the switch performs required actions.

In an embodiment, a law enforcement agency 300 instructs 412 the gateway 302 which users or devices are to be intercepted. This information may be transmitted via a secured, encrypted channel. The identity of the UE to be intercepted may be stored in an internal LI database. The database of users under interception cannot be accessed by operator O&M personnel.

The user equipment may be identified by Mobile Subscriber Integrated Services Digital Network Number (MSISDN), International mobile subscriber identity (IMSI) or International Mobile Station Equipment Identity (IMEI), for example.

When a communication session is created 500 for UE the gateway 302 is configured to internally match the user identity to the internal LI database and in case the UE is to be intercepted, the gateway transmits 414 via a secure channel the OpenFlow controller a command to intercept the specific session. The session may be identified by session Internet Protocol (IP) address or a General packet radio service (GPRS) tunnelling protocol (GTP) tunnel endpoint identifier (TEID), for example.

The OpenFlow controller 402 is configured to create or modify a processing rule regarding the user equipment by including interception in the rule and transmit to the OpenFlow Switch 400 using a secure channel 408 an OpenFlow protocol a command 502 to clone and encrypt each signalling or data packet of the user equipment connection and to transmit the encrypted signalling and data packets to a given network apparatus.

If a processing rule regarding the user equipment exists, the OpenFlow controller 402 is configured to modify the processing rule by including interception in the rule.

If a processing rule regarding the user equipment does not exist, the OpenFlow controller 402 is configured to create the processing rule and include interception command in the rule.

The O&M apparatuses or personnel are not able to see or examine the rules related to interception located in the OpenFlow Controller.

The OpenFlow Switch 400 receives the command related to a given user equipment connection. The switch receives signalling 504 and data 506 packets from user equipment. The switch is clones each packet of the designated session. Packets are sent 416, 418 to a given output port which is connected to the Gateway 302 as usual. However, the cloned packets are sent to another predetermined output port of the switch.

In an embodiment, the OpenFlow Switch 400 comprises an encryption module 420 listening to a predefined port of the switch predetermined output port and encrypting each cloned signalling or data packet arriving to the port. The encryption module 420 is further configured to transmit the encrypted signalling 422 and data 424 packets to the LEA 300.

The gateway 302 is further configured to transmit 308 interception related information IRI (network related data) to the LEA 300.

In the above example solution for LI, the virtual gateways are relieved of any additional processing overhead for the encryption process. Further, the encryption module 420 of the OpenFlow switch 400 can be optimized or hardware accelerated if better performance is needed, and the module may be completely independent of the performance of the gateway 302.

In an embodiment, the encryption module 420 of the OpenFlow switch 400 is configured to communicate with the LI center to establish necessary security details such as encryption and authentication handshakes. The switch exposes a new application program interface API to configure the encryption module. As the encryption module 420 is located inside the OpenFlow switch 400, it is not possible for an outsider or the operator personnel to deduce the subscriber identity from the traffic. The selection of subscribers is done in the OpenFlow controller 402, and the instruction comes via a secure channel 408. Furthermore, the OpenFlow tables 410 related to LI (pointing to encryption module) are inside the switch and related entries in the OpenFlow controller may be secured and restricted from operator O&M personnel access. The intercepted user plane traffic goes to the LI center via a secure channel as well making it difficult for anyone outside the legal authority to deduce the identity of the subscriber under scrutiny.

In some present solutions for LI the processing of LI traffic is done within the gateway and then forwarded to the LI entity via an encryption channel. Thus, the gateway is loaded with the extra processing for encryption of the user plane data which can be very big in current load scenario. In an embodiment of the invention, the whole process is offloaded from the gateway, and is located in the OpenFlow switch where a dedicated encryption module can take care of the encryption and forwarding part. Moreover, with hundreds of virtual gateways, the Openflow switch may handle all the LI subscribers from the gateways, thus making it even more difficult to statistically deduce the identity of the subscriber under LI scrutiny.

FIG. 6 shows an example of a block diagram of the structure of an apparatus according to an example embodiment. The apparatus of an example embodiment need not be the entire apparatus, but may be a component or group of components of the apparatus in other example embodiments.

A processor 600 is configured to execute instructions and to carry out operations associated with the apparatus. The processor 600 may comprise means, such as a digital signal processor device, a microprocessor device, and circuitry, for performing various functions including, for example, one or more of the functions described in conjunction with FIGS. 1 to 5. The processor 600 may control the reception and processing of input and output data between components of the apparatus by using instructions retrieved from memory. The processor 600 can be implemented on a single-chip, multiple chips or multiple electrical components. Some examples of architectures which can be used for the processor 600 include dedicated or embedded processor, and ASIC.

The processor 600 may comprise functionality to operate one or more computer programs 604. Computer program code may be stored in a memory 602. The at least one memory and the computer program code may be configured to, with the at least one processor, cause the apparatus to perform at least one embodiment including, for example, one or more of the functions described in conjunction with FIGS. 1 to 5. Typically the processor 602 operates together with an operating system to execute computer code and produce and use data.

By way of example, the memory 602 may include non-volatile portion, such as EEPROM, flash memory or the like, and a volatile portion, such as a random access memory (RAM) including a cache area for temporary storage of data. The information could also reside on a removable storage medium and loaded or installed onto the apparatus when needed.

The apparatus may comprise an interface 606 for communicating with other apparatuses or network devices.

The apparatus may operate with one or more communication protocols.

The apparatus may comprise also further units and elements not illustrated in FIG. 6, such as further interface devices, a power unit or a battery, for example.

In an embodiment, the apparatus of FIG. 6 is an OpenFlow Controller 402 configured to receive from a gateway apparatus an intercept request regarding user equipment in the communication system; create or modify a processing rule regarding the user equipment by including interception in the rule; transmit to a network switch processing user equipment connections a command to clone and encrypt each signalling or data packet of the user equipment connection and to transmit the encrypted signalling and data packets to a given network apparatus.

In an embodiment, the apparatus of FIG. 6 is an OpenFlow Switch 400 configured to process user equipment connections by directing data signalling packets between user equipment and a gateway apparatus; receive from a controlling network element an intercept command related to a given user equipment connection; clone and encrypt each signalling or data packet of the given user equipment connection; encrypt the cloned signalling and data packets; and transmit the encrypted signalling and data packets to a given network apparatus. The apparatus may store flow table or tables in memory 602. The interface 606 may comprise output ports connected to different network devices such as a gateway 302 or law enforcement agency (LEA) 300. The apparatus may comprise an encryption module realized with the processor 600 and memory 602, for example.

In an embodiment, the apparatus of FIG. 6 is a gateway 302 configured to receive from law enforcement agency (LEA) 300 an intercept request regarding user equipment in the communication system, obtain information that a connection has been set up for the user equipment; transmit to an OpenFlow Controller 402 apparatus a command to intercept user equipment connection, the command comprising identification of the connection; and transmit to the law enforcement agency (LEA) 300 interception related information (IRI). As previously described the processor and memory may be realized with cloud computing i.e. several computing platforms securely connected via Internet or other networks.

Embodiments of the present invention may be implemented in software, hardware, application logic or a combination of software, hardware and application logic. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 8. A computer-readable medium may comprise a computer-readable storage medium that may be any media or means that can contain or store the instructions for use by or in connection with an instruction execution system, apparatus, or device, such as a computer.

If desired, at least some of the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense.

Rather, there are several variations and modifications which may be made without departing from the scope of the present invention as defined in the appended claims.

1. An apparatus in a communication system, said apparatus comprising:
at least one processor; and
at least one memory including computer program code, the at least one memory and the computer program code configured to, with the at least one processor, cause the apparatus at least to perform:
receiving from a network apparatus an intercept request regarding a user equipment in the communication system,
obtaining information that a connection has been set up for the user equipment;
transmitting, to a controlling network element that is controlling a network switch, a command to intercept the user equipment connection, the command comprising identification of the connection; and
transmitting to the network apparatus interception related information.

2. The apparatus of claim 1, wherein the user equipment is identified by mobile subscriber integrated services digital network number, international mobile subscriber identity or international mobile station equipment identity.

3. The apparatus of claim 1, wherein the user equipment connection is identified by an internet protocol address or a general packet radio service tunnelling protocol tunnel identifier.

4. A method in a communication system, comprising:
receiving, by a gateway apparatus, from a network apparatus an intercept request regarding user equipment in the communication system;
obtaining information that a connection has been set up for the user equipment;
transmitting, to a controlling network element that is controlling a network switch, a command to intercept the user equipment connection, the command comprising identification of the connection;
transmitting to the network apparatus interception related information.

5. The method of claim 4, wherein the user equipment is identified by mobile subscriber integrated services digital network number, international mobile subscriber identity or international mobile station equipment identity.

6. The method of claim 4, wherein the user equipment connection is identified by an internet protocol address or a general packet radio service tunnelling protocol tunnel endpoint identifier.

7. A computer program embodied on a non-transitory computer readable medium, said computer readable medium encoding instructions which, when executed by one or more processors of an apparatus, cause the apparatus to perform:
receiving, by a gateway apparatus, from a network apparatus an intercept request regarding user equipment in the communication system;
obtaining information that a connection has been set up for the user equipment;
transmitting, to a controlling network element that is controlling a network switch, a command to intercept the user equipment connection, the command comprising identification of the connection;
transmitting to the network apparatus interception related information.

8. The computer program according to claim 7, wherein the user equipment is identified by mobile subscriber integrated services digital network number, international mobile subscriber identity or international mobile station equipment identity.

9. The computer program according to claim 7, wherein the user equipment connection is identified by an internet protocol address or a general packet radio service tunnelling protocol tunnel endpoint identifier.
